(19) United States
(12) Patent Application Publication
(10) Pub. No.: US 2009/0063044 A1
(43) Pub. Date: Mar. 5, 2009

(54) Navigation apparatus and information service system

(75) Inventor: Shigehiro Mutoh, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/230,349

(22) Filed: Aug. 28, 2008

(30) Foreign Application Priority Data
Sep. 5, 2007 (JP) 2007-230320

(51) Int. Cl. G01C 21/34

(52) U.S. Cl. 701/209

(57) ABSTRACT

A navigation apparatus in a vehicle acquires from an outside (i) introduced party link information relative to introduced facilities, which are introduced by facilities, and (ii) introducing party link information relative to introducing facilities, which introduce facilities. If a first facility, which satisfies a search condition inputted by a user, is provided with (i) introduced party link information relative to introduced facilities which the first facility introduces, and/or (ii) introducing party link information relative to introducing facilities which introduce the first facility; the navigation apparatus displays the introduced party link information and/or introducing party link information, If the user selects an introduced facility or an introducing facility from the displayed link information, the navigation apparatus designates, as a new destination, the selected introduced facility or introducing facility.

### CROSS REFERENCE TO RELATED APPLICATION

This application is based on and incorporates herein by reference Japanese Patent Application No. 2007-230320 filed on Sep. 5, 2007.

### FIELD OF THE INVENTION

The present invention relates to a navigation apparatus and an information service system.

### BACKGROUND OF THE INVENTION

In a known vehicular navigation apparatus, when a user inputs a search condition (for example, a name, facility genre, address, telephone number), a facility satisfying the search condition is designated as a destination. The following case may happen. A user designates a first restaurant as a destination and then eats and drinks in the first restaurant; in the next opportunity, the user wants to eat and drink in a second restaurant which belongs to the same affiliation as the first restaurant. In such a case, if the user recognizes the search condition for restaurants belonging to the same affiliation, it is possible for the user to designate as a destination a restaurant belonging to the same affiliation by inputting the recognized search condition.

Herein, to designate as a destination the relevant restaurant, the user still needs to input the search condition and, further, the user naturally needs to recognize or remember the search condition of the restaurants of the same affiliation. For instance, an information service system disclosed in Patent Document 1 makes a procedure of trackback easy and makes operations of comments and trackbacks transparent to users.

However, the technology indicated in Patent Document 1 may not eliminate bothersome procedures of users for designating a destination.
Patent document 1: JP-2005-250826 A

### SUMMARY OF THE INVENTION

It is an object to provide a navigation apparatus for a vehicle and an information service system, which allows users to easily designate a desirable facility as a destination and improves convenience of users.

According to a first example of the present invention, a navigation apparatus for a vehicle is provided as follows. A search condition input portion is configured for a user to input a search condition. A control device is configured to designate as a destination a facility which satisfies the inputted search condition. An introduced party link acquisition portion is configured to acquire introduced party link information relative to a facility a predetermined facility introduces. An introduced facility selection portion is configured for the user to select an introduced facility included in the acquired introduced party link information. Herein, when a first facility, which satisfies the inputted search condition, is provided with introduced party link information relative to a facility the first facility introduces, (i) the control device reports using a reporting portion, to the user, the introduced party link information relative to the facility the first facility introduces, and (ii) the control device designates as a new destination an introduced facility selected by the user from the reported link information via the introduced facility selection portion.

As a second example of the present invention, a navigation apparatus for a vehicle is provided as follows. A search condition input portion is configured for a user to input a search condition. A control device is configured to designate as a destination a facility which satisfies the inputted search condition. An introducing party link acquisition portion is configured to acquire introducing party link information relative to a facility which introduces a predetermined facility. An introducing facility selection portion is configured for the user to select an introducing facility included in the acquired introducing party link information. Herein, when a first facility, which satisfies the inputted search condition, is provided with linking party information relative to a facility which introduces the first facility, (i) the control device reports, using a reporting portion to the user, the introducing party link information relative to an introducing facility which introduces the first facility, and (ii) the control device designates as a new destination an introducing facility selected by the user from the reported link information via the introducing facility selection portion.

As a third example of the present invention, a navigation apparatus for a vehicle is provided as follows. A search condition input portion is configured for a user to input a search condition. A control device is configured to designate as a destination a facility which satisfies the inputted search condition. An associated party link acquisition portion is configured to acquire associated party link information relative to a facility, with which a predetermined facility is associated. An associated facility selection portion is configured for the user to select an associated facility included in the acquired associated party link information. Herein, when a first facility, which satisfies the inputted search condition, is provided with associated party link information relative to a facility the first facility is associated with, (i) the control device reports using a reporting portion, to the user, the associated party link information relative to the facility the first facility is associated with, and (ii) the control device designates as a new destination an associated facility selected by the user from the reported link information via the associated facility selection portion.

Further, the associated facility, which the facility satisfying the search condition is associated with, may include at least one of (i) an introduced facility, which the facility satisfying the search condition introduces and (ii) an introducing facility, which introduces the facility satisfying the search condition.

Under the above configuration of the navigation apparatus according to any one of the first to third example, when a user inputs a search condition, the facility which satisfies the search condition can be set as a destination point. Herein, if the facility satisfying the search condition is associated with a certain facility, a new destination can be assigned to the certain facility without requiring the user to input a search condition again. Thus, if the user once inputs a search condition, the user can designate, as a new destination, any one of candidates which include facilities associated with the facility satisfying the inputted search condition. The user can thus easily designate a facility desirable as a destination to thereby improve convenience of the user.

As another example of the present invention, an information service system is provided by comprising: (i) the navigation apparatus according any one of the first to third example; and (ii) an associated party link storage portion for storing corresponding associated party link information.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram illustrating an overall configuration of an information service system according to an embodiment of the present invention;

FIG. 2 is a block diagram illustrating a configuration of a vehicular navigation apparatus;

FIG. 3 is a diagram illustrating an example of a configuration of facility data;

FIG. 4 is a diagram illustrating an example of relation where shops introduce each other;

FIG. 5 is a diagram illustrating an example of a configuration of facility data;

FIG. 6 is a diagram illustrating an example of a configuration of facility data;

FIG. 7 is a flowchart;

FIGS. 8A, 8B are examples of destination designation windows;

FIGS. 9A, 9B, 10A, 10B are examples of list windows of introduced party link information; and

FIGS. 11A, 11B, 12A, 12B are examples of list windows of introducing party link information.

### DETAILED DESCRIPTION OF THE PREFERRED EMBODIMENTS

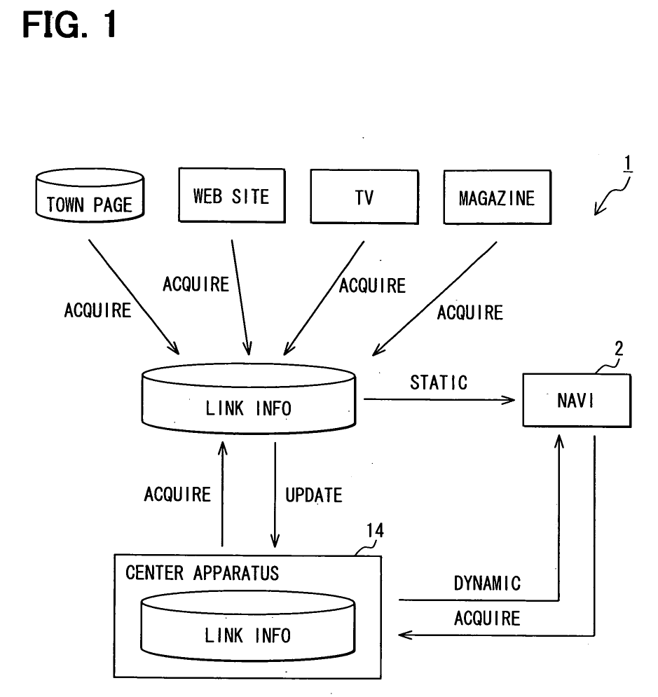

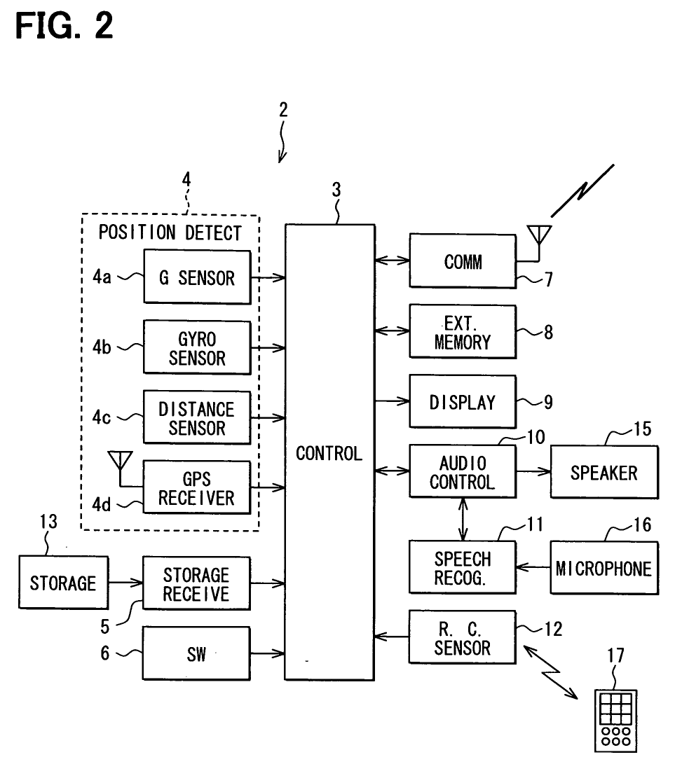

An embodiment according to the present invention will be explained with reference to drawings. The embodiment is directed to an information service system 1 and a vehicular navigation apparatus 2. FIG. 1 illustrates an overall configuration of the information service system 1, which includes the navigation apparatus 1 and others. FIG. 2 illustrates, as a block diagram, an overall configuration of the navigation apparatus 2 provided in a subject vehicle. The navigation apparatus 2 includes the following: a control device 3 (also functioning as an example of a present position designation means or portion); a position detection device 4; a storage medium reception device 5 (also functioning as an example of an introduced party link acquisition means or portion, introducing party link acquisition means or portion, or a storage medium reception means or portion); an operation switch group 6 (also functioning as an example of a search condition input means or portion, an introduced facility selection means or portion, or an introducing facility selection means or portion); a communication device 7 (also functioning as an example of a communication means or portion, an introduced party link acquisition means or portion, or an introducing party link acquisition means or portion); an external memory 8; a display device 9 (also functioning as an example of a reporting means or portion); an audio controller 10; a speech recognition device 11; and a remote control sensor 12.

The control device 3 has a CPU, a RAM, a ROM, and an I/O bus, executing a control program to control operation of the whole apparatus. The position detection device 4 includes a G sensor 4a, a gyroscope 4b, a distance sensor 4c, and a GPS (Global Positioning System) receiver 4d. These sensors or the like have individual types of detection errors different from each other. The control device 3 complements detection signals inputted from these sensors or the like with each other to thereby detect or designate a present position of the subject vehicle. In addition, the position detection device 4 may not need all the sensors or the like, depending on required detection accuracy. Moreover, the position detection device 4 may further include a steering sensor for detecting a steering angle, and a wheel sensor for detecting rotation of wheels.

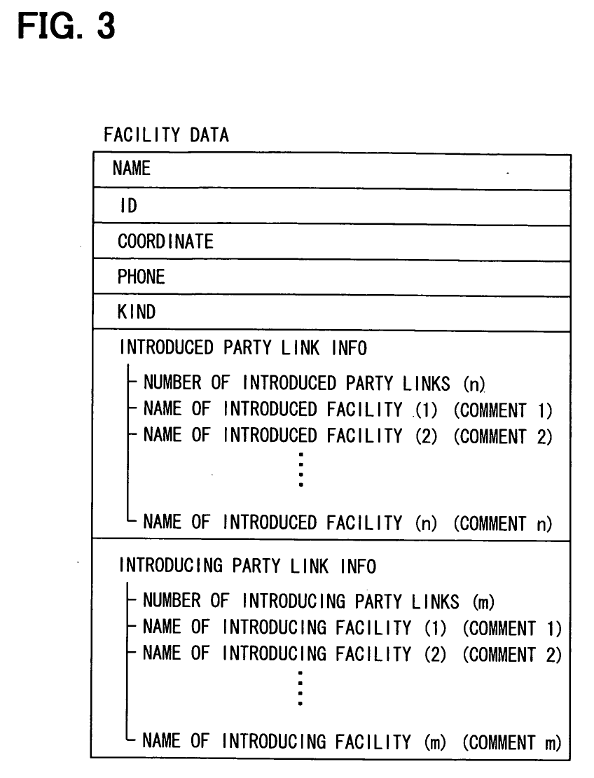

The storage medium reception device 5 receives a storage medium 13, such as a CD-ROM, DVD-ROM, HDD, and memory card. The storage medium 13 stores or records facility data as well as map data, landmark data, and data for map matching. As shown in FIG. 3, the facility data includes with respect to each facility as a data unit, a facility name, a facility ID unique to the facility, a position coordinate indicating the position, a telephone number, a class or kind, and link information (introduced party link information and introducing party link information). Introduced party link information is information about another facility which the relevant facility introduces, and includes the number (n) of introduced party links, which indicates the number of facilities introduced by the relevant facility, and introduced facility names (1) to (n), which indicate names of the facilities introduced by the relevant facility. Herein, “n” is a natural number. Introducing party link information is information about another facility which introduces the relevant facility, and includes the number (m) of introducing party links, which indicates the number of facilities introducing the relevant facility, and introducing facility names (1) to (m), which indicate names of the facilities introducing the relevant facility. Herein, “m” is a natural number.

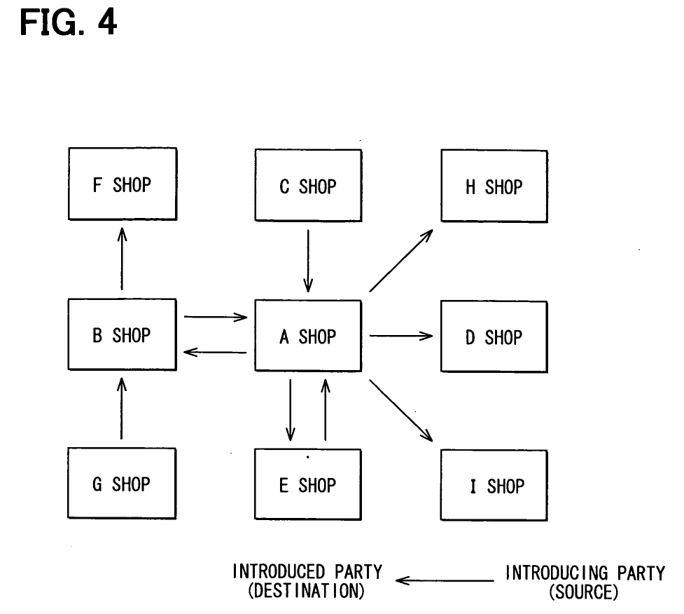

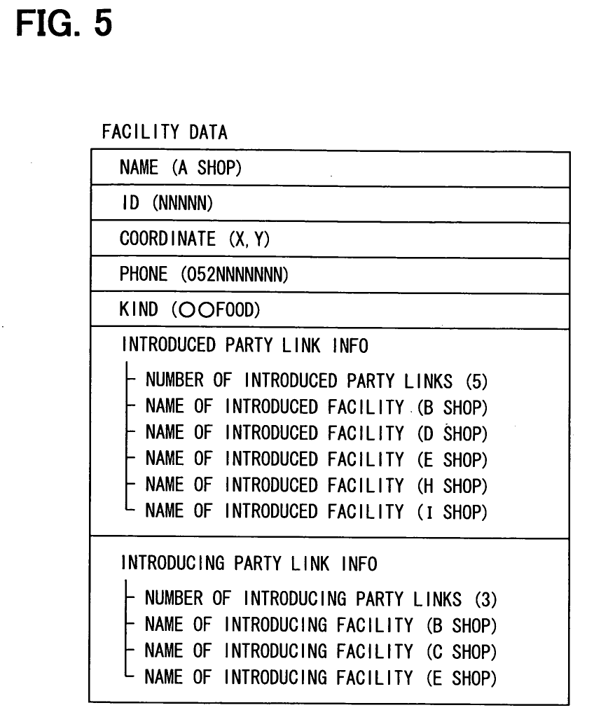

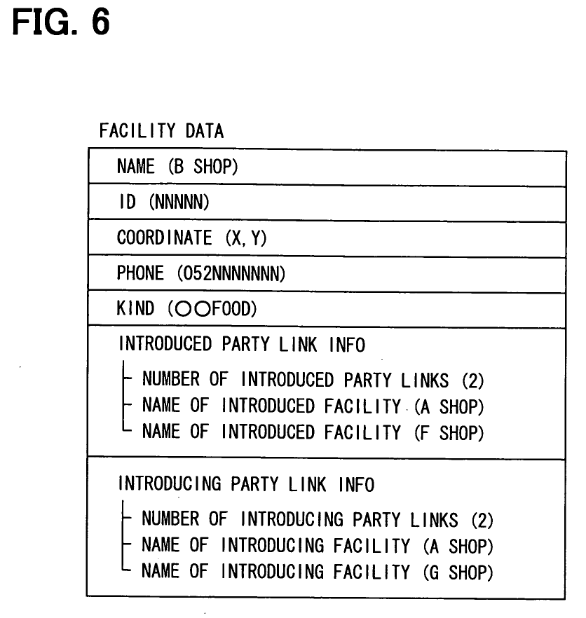

For instance, FIG. 4 illustrates a relation where nine shops (as facilities) of “A SHOP” to “I SHOP” introduce or link each other. In the facility data about “A SHOP,” “A SHOP” introduces five shops of “B SHOP,” “D SHOP,” “E SHOP,” “H SHOP,” and “I SHOP”; in contrast, “A SHOP” is introduced by three shops of “B SHOP,” “C SHOP,” and “E SHOP.” Thus, in FIG. 5 with respect to the facility data of “A SHOP,” the number of introduced party links is set to “5,” and the number of introducing party links is set to “3.” In addition, in the facility data about “B SHOP,” “B SHOP” introduces two shops of “A SHOP” and “F SHOP”; in contrast, “B SHOP” is introduced by two shops of “A SHOP” and “G store.” Thus, in FIG. 6 with respect to the facility data of “B SHOP,” the number of introduced party links is set to “2,” and the number of introducing party links is set to “2.” In addition, introduced party link information is for the relevant facility to introduce another facility, so the introduced party link information also records comments (e.g., impression, evaluation) for every introduced facility.

The operation switch group 6 also functions as an example of a search condition input means or portion, an introduced facility selection means or portion, or an introducing facility selection means or portion. The operation switch group 6 includes a mechanical switch arranged in a periphery of the display device 9, or a touch sensitive switch formed on the display device 9. The operation switch group 6 detects an operation by a user to thereby output an operation detection signal to the control device 3.

The communication device 7 establishes a communication link to communicate with a center apparatus 14, which is disposed within a communication network. The center apparatus 14 functions as an example of an introduced party link storage means or portion, and an introducing party link storage means or portion.

The external memory 8 includes a high-capacity storage device such as an HDD to store large volume data.

The display device 9 includes, for example, a color liquid crystal display. The display device 9 displays various kinds of display windows, such as a menu window and destination designation window while superimposing a present position mark for indicating a present position of the vehicle, a vehicular swept path, and the like on a map generated from map data. In addition, the display device 9 may include an organic electroluminescence (EL) or a plasma display.

The audio controller 10 controls the speech recognition device 11 and outputs, for example, a route guidance message, a warning message via a speaker 15. The speech recognition device 11 performs speech recognition of sounds or speeches inputted via a microphone 16 based on a speech-recognition algorithm.

The remote control sensor 12 receives an operation detection signal from a remote control 17 to thereby detect the operation information which the user executes, and output an operation detection signal to the control device 3. The remote control 17 functions as an example of a search condition input means or portion, an introduced facility selection means or portion, and an introducing facility selection means or portion.

The control device 3 has known functions for navigation such as a map matching function, a route retrieval function, a route guidance function (or navigating function), and an image rendering function. The map matching function performs a map matching process to designate a road where the present position of the vehicle is located by using road data included in the map data and the detected present position of the vehicle. The route retrieval function retrieves a route to a destination designated by a user from the present position designated by the map matching process. The route guidance function performs route guidance by calculating a point required for route guidance based on road data and positions of intersections contained in the map data, and retrieved route. The image rendering function renders a peripheral map around a present position of the vehicle, a schematic drawing of a highway, an enlarged view near an intersection, etc.

The above-mentioned link information (introduced party link information and introducing party link information) is managed by a third-party organization, for example. Such information is acquired or collected via the media, such as a town page (telephone book dedicated for facilities), website, television, and magazine, as illustrated in FIG. 1. The link information is deployed to the navigation apparatus 2 in the following modes, for example. In a first mode, the link information is recorded in a detachable storage medium 13; the storage medium 13 is inserted into or received by the reception device 5 of the navigation apparatus 2; thus, the link information is statically deployed to the navigation apparatus 2 to be thereby held in the external memory 8. In a second mode, the link information is recorded in the center apparatus 14; the center apparatus 14 communicates with the communication device 7 of the subject vehicle via the communication link; thus, the link information is dynamically deployed to the navigation apparatus 2 to be thereby held in the external memory 8. If the link information is updated in the center apparatus 14 each time being changed, the most recently updated link information is continuously or dynamically acquirable. The dynamic deployment using the communication link is thus more advantageous than the static deployment using the detachable storage medium.

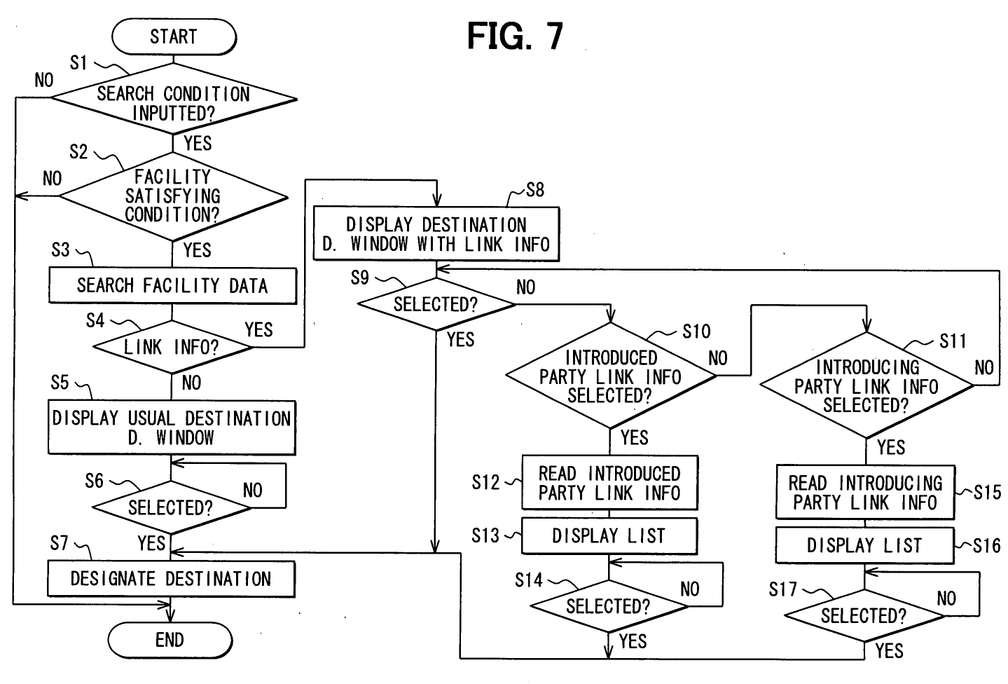

An operation under the above configuration is explained with reference to FIGS. 7 to 12B. The following explains a process executed by the control device 3 when a user inputs a search condition to thereby designate a destination. At S1, the control device 3 monitors whether a user operates the operation switch group 6 or the remote control 17 to input a search condition (for example, a name, a facility genre, an address, a telephone number). When the control device 3 determines that the user operates the operation switch group 6 or the remote control 17 and inputs a search condition (“YES” at S1), it is determined at S2 whether a facility exists which satisfies the inputted search condition. It is determined that a facility exists which satisfies the inputted search condition (“YES” at S2), the facility data stored in the external memory 8 is searched at S3. It is determined at S4 whether the facility satisfying the search condition is a facility which is provided with link information. In other words, it is determined at S4 whether the facility data relative to the facility satisfying the search condition includes the link information.

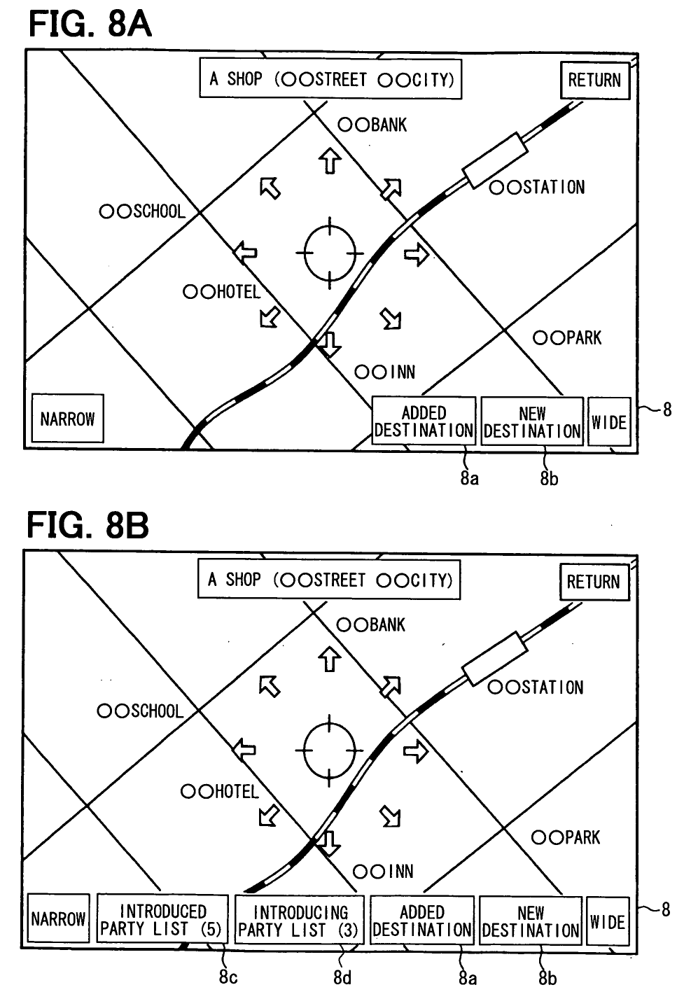

When it is determined that the facility satisfying the search condition is not a facility which is provided with link information (“NO” at S4), a usual destination designation window is displayed in the display device 9 at S5, as illustrated in FIG. 8A. It is monitored or determined at S6 whether an operation for designating a destination is executed. When it is determined that the user operates “ADDED DESTINATION” switch 8a or “NEW DESTINATION” switch 8b on the usual destination designation window to thereby select destination designation (“YES” at S6), the facility satisfying the search condition is designated as a destination at S7.

In contrast, when it is determined that the facility satisfying the search condition is a facility which is provided with link information (“YES” at S4), a destination designation window with link information is displayed in the display device 9 at S8. The destination designation window with link information has “INTRODUCED PARTY LINK” switch 8c and “INTRODUCING PARTY LINK” switch 8d in addition to the above-mentioned “ADDED DESTINATION” switch 8a and “NEW DESTINATION” switch 8b, as illustrated in FIG. 8B. It is monitored at S9 whether an operation for designating a destination is executed. It is monitored at S10 whether an operation for displaying a list of introduced party link information is executed. It is monitored at S11 whether an operation for displaying a list of introducing party link information is executed. When it is determined that the user operates “ADDED DESTINATION” switch 8a or “NEW DESTINATION” switch 8b on the destination designation window with link information to thereby select destination designation (“YES” at S8), the facility satisfying the search condition is designated as a destination at S7 similarly with the above.

When it is determined that the user operates “INTRODUCED PARTY LINK” switch 8c on the destination designation window with link information to thereby select introduced party information list display (“YES” at S10), the introduced party link information, which the facility satisfying the search condition is provided with, read from the external memory 8 at S12. The list of introduced facilities is displayed in the display device 9 at S13. It is monitored at S14 whether an operation for designating a facility selection is executed. When the control device 3 determines that the user selects any one from the introduced facilities in the list (“YES” at S14), the facility selected by the user is designated as a destination at S7.

When it is determined that the user operates “INTRODUCING PARTY LINK” switch 8d on the destination designation window with link information to thereby select introducing party link information list display (“YES” at S11), the introducing party link information, which the facility satisfying the search condition is provided with, is read from the external memory 8 at S15. The list of introducing facilities is displayed in the display device 9 at S16. It is monitored at S17 whether an operation for designating a facility selection is executed. When the control device 3 determines that the user selects any one from the introducing facilities in the list (“YES” at S17), the facility selected by the user is designated as a destination at S7.

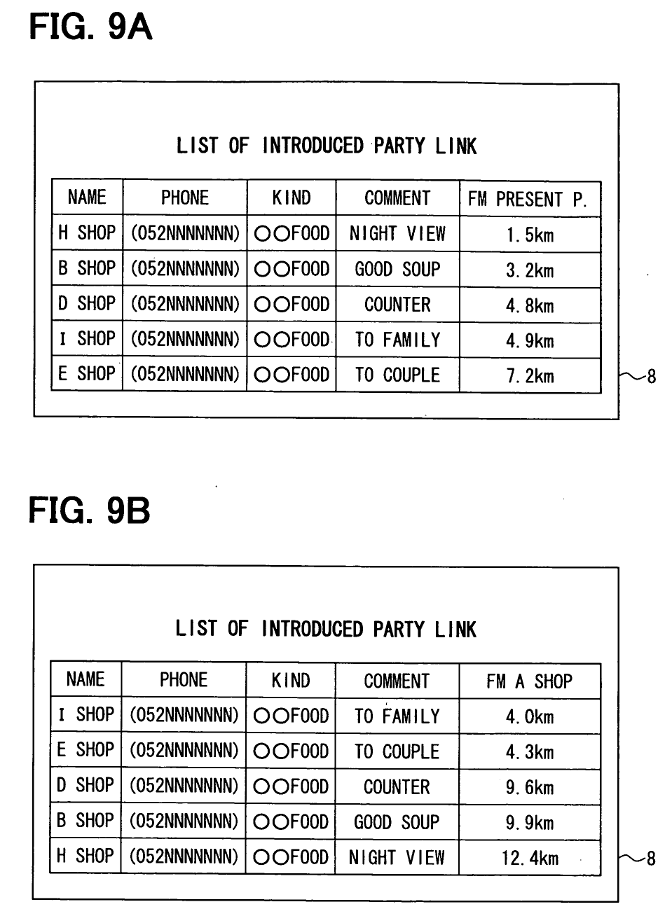

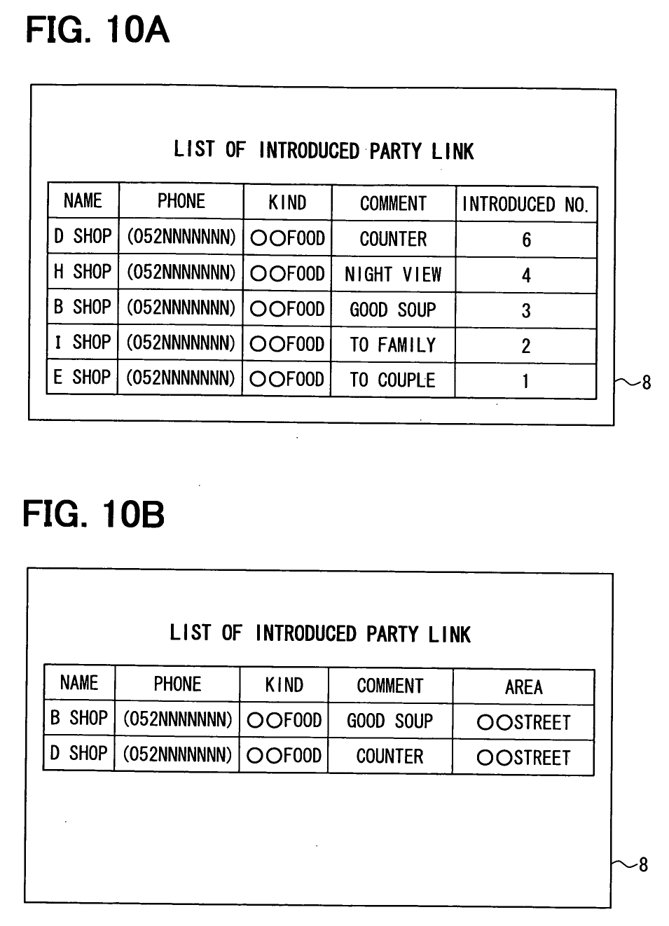

For instance, “A SHOP” is assumed as satisfying the search condition the user inputted; the facility data of “A SHOP” includes both introduced party link information and introducing party link information as shown in FIG. 5. The control device 3 thus displays the destination designation window with link information while approximately centering the position of “A SHOP” satisfying the inputted search condition on the window, as illustrated in FIG. 8B. When the user then operates “INTRODUCED PARTY LINK” switch 8c, the list of five shops of “B SHOP,” “D SHOP,” “E SHOP,” “H SHOP,” and “I SHOP” which are introduced by “A SHOP,” as illustrated in FIGS. 9A, 9B and FIGS. 10A, 10B. In such a case, the control device 3 may display these five shops in the distance-increasing order from the shop or distance closest to the present position, as illustrated in FIG. 9A. Alternatively, the shops may be listed in the distance-increasing order from the shop or distance closest to “A SHOP,” as illustrated in FIG. 9B. Alternatively, the shops may be listed in a decreasing order from the shop which is most often introduced by other shops or facilities including “A SHOP,” as illustrated in FIG. 10A. In other words, the shops are listed in a descending order of the number of the facilities introducing the relevant shop. Further, only shops located in a limited area may be listed as illustrated in FIG. 10B. Thus, the user can select any one among the five shops of “B SHOP,” “D SHOP,” “E SHOP,” “H SHOP,” and “I SHOP” which are introduced by “A SHOP,” to thereby designate the selected shop as a destination.

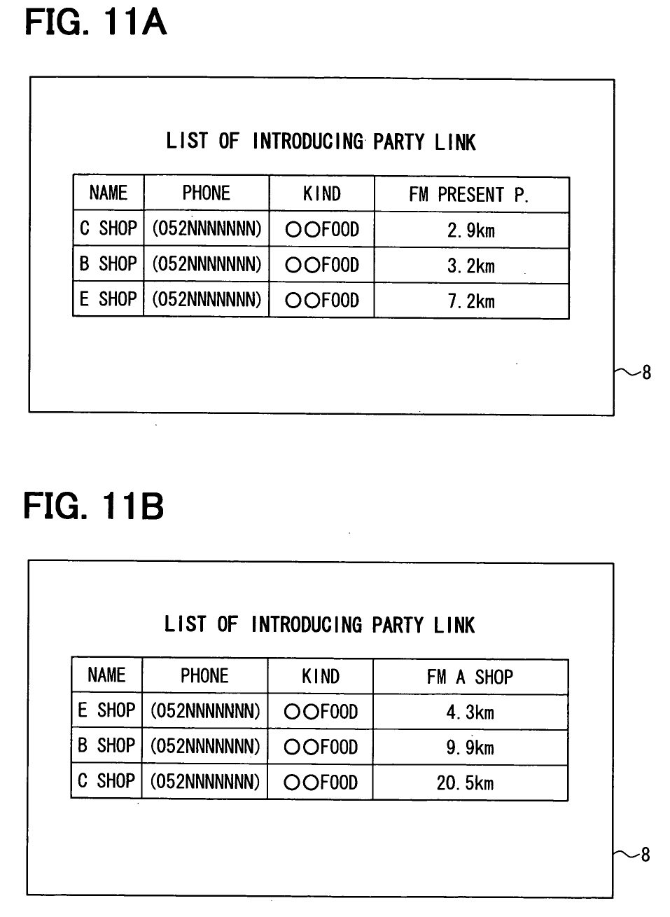

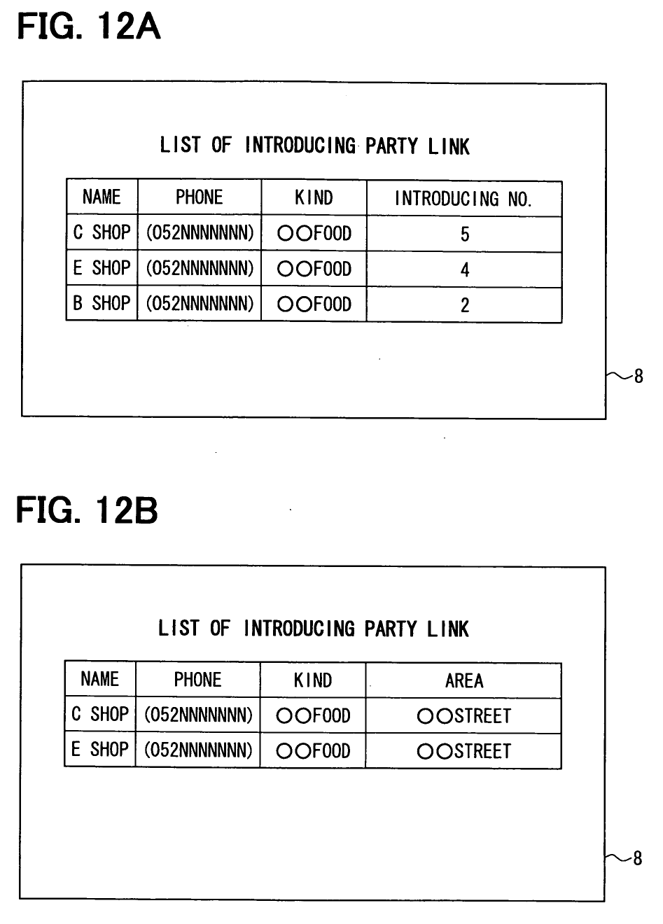

In contrast, when the user operates “INTRODUCING PARTY LINK” switch 8d, the list of three shops of “B SHOP,” “C SHOP,” and “E SHOP,” as illustrated in FIGS. 11A, 11B and FIGS. 12A, 12B. In this case, the control device 3 may display these three shops in the distance-increasing order from the shop or distance closest to the present position, as illustrated in FIG. 11A. Alternatively, the shops are listed in the distance-increasing order from the shop or distance closest to “A SHOP,” as illustrated in FIG. 11B. Alternatively, the shops may be listed in a decreasing order from the shop which introduces most often other shops or facilities including “A SHOP,” as illustrated in FIG. 12A. In other words, the shops are listed in a descending order of the number of the facilities including the relevant shop which the relevant shop introduces. Further, only shops located in a limited area may be listed as illustrated in FIG. 12B. Thus, the user can select any one among the three shops of “B SHOP,” “C SHOP,” and “E SHOP” which introduce “A SHOP,” to thereby designate the selected shop as a destination.

The above embodiment explains the case where A shop satisfying the search condition inputted by the user is provided with both introduced party link information and introducing party link information, i.e., the facility data of A shop includes both introduced party link information and introducing party link information. If a facility satisfying a search condition inputted by a user is provided with either introduced party link information or introducing party link information, the control device 3 may display a destination designation window with link information which has either “INTRODUCED PARTY LINK” switch 8c or “INTRODUCING PARTY LINK” switch 8d in the display device 9.

In addition, as explained above, the link information can be collected or acquired via the media, such as town page, website, television, and magazine by using the storage medium 13. Further, also as explained above, it can be acquired as follows. A user operates the operation switch group 6 or the remote control 17 to thereby cause the navigation apparatus 2 to communicate with the center apparatus 14 via the communication link; thus, the link information can be acquired from the center apparatus 14 via the communication link.

As mentioned above, according to the present embodiment, the vehicular navigation apparatus 2 acquires (i) introduced party link information relative to facilities which are introduced by a subject facility and/or (ii) introducing party link information relative to facilities which introduce the subject facility, from the storage medium 13 or the center apparatus 14. If the facility satisfying a search condition inputted by a user is a facility which is provided with introduced party link information and/or introducing party link information, the navigation apparatus 2 displays the acquired introduced party link information and/or the acquired introducing party link information. If the user selects a linked facility or introducing facility from the displayed information, the navigation apparatus 2 designates, as a new destination, the selected introduced facility or introducing facility. Herein, (i) introduced party link information relative to facilities which are introduced by a subject facility and (ii) introducing party link information relative to facilities which introduce the subject facility can be generically referred to as associated party link information relative to facilities which the subject facility is associated with.

Thus, without requiring a user to input a search condition again, a new destination can be assigned to another facility which is introduced by the facility satisfying a search condition inputted by the user, or to another facility which introduces the facility satisfying the search condition inputted by the user. Thus, if the user once inputs a search condition, the user can designate, as a new destination, any one of candidates which include (i) facilities introduced by the facility satisfying the inputted search condition and (ii) facilities which introduce the facility satisfying the inputted search condition. The user can thus easily designate a desirable facility as a destination.

The present invention is not limited only to the above-mentioned embodiment, and can be modified or extended as follows. In displaying as a list the introduced facilities or the introducing facilities, the facility kind can be limited and displayed. Further, any combinations of the following parameters can be designed: the distance from the present position, the distance from the facility satisfying the search condition, the number of introduced facilities, the number of introducing facilities, the area, and the kind. In addition, the introduced facilities and the introducing facilities can be simultaneously displayed within a single list in the display device 9.

Further, the following configuration can be further designed; namely, after a certain facility is selected from the introducing facilities or the introduced facilities, it is determined whether the certain facility is provided with link information. When the certain facility is provided with link information, the similar processing may be performed to linking other facilities to thereby designate as a destination the newly selected facility. That is, a new destination can be assigned to another facility introduced by a facility, which is originally introduced by a facility satisfying a search condition inputted by the user; in addition, a new destination can be assigned to another facility introducing a facility, which originally introduces a facility satisfying a search condition inputted by the user.

Each or any combination of processes, steps, or means explained in the above can be achieved as a software portion or unit (e.g., subroutine) and/or a hardware portion or unit (e.g., circuit or integrated circuit), including or not including a function of a related device; furthermore, the hardware portion or unit can be constructed inside of a microcomputer.

Furthermore, the software portion or unit or any combinations of multiple software portions or units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A navigation apparatus for a vehicle, the apparatus comprising:
a search condition input means for a user to input a search condition;
a control device that designates as a destination a facility which satisfies the inputted search condition;
an introduced party link acquisition means for acquiring introduced party link information relative to a facility a predetermined facility introduces; and
an introduced facility selection means for the user to select an introduced facility included in the acquired introduced party link information,
wherein when a first facility, which satisfies the inputted search condition, is provided with introduced party link information relative to a facility the first facility introduces,
(i) the control device reports using a reporting means, to the user, the introduced party link information relative to the facility the first facility introduces, and
(ii) the control device designates as a new destination an introduced facility selected by the user from the reported link information via the introduced facility selection means.

2. The navigation apparatus according to claim 1, further comprising:
a present position designation means for designating a present position,
wherein when the introduced party link information, with which the first facility satisfying the inputted search condition is provided, includes a plurality of introduced facilities,
(i) the control device reports using the reporting means to the user the plurality of introduced facilities in an order of a distance from the present position, and
(ii) the control device designates as a new destination an introduced facility selected by the user from the plurality of introduced facilities included in the reported link information via the introduced facility selection means.

3. The navigation apparatus according to claim 1, wherein
when the introduced party link information, with which the first facility satisfying the inputted search condition is provided, includes a plurality of introduced facilities,
(i) the control device reports to the user the plurality of introduced facilities in an order of a distance from the first facility, and
(ii) the control device designates as a new destination an introduced facility selected by the user from the plurality of introduce facilities included in the reported link information via the introduced facility selection means.

4. The navigation apparatus according to claim 1, wherein:
the introduced party link acquisition means includes a storage medium reception means for receiving a detachable storage medium; and
the introduced party link acquisition means acquires the introduced party link information when the storage medium reception means receives a storage medium including the introduced party link information.

5. The navigation apparatus according to claim 1, wherein:
the introduced party link acquisition means includes a communication means; and
the introduced party link acquisition means acquires the introduced party link information when the communication means communicates with a center apparatus including the introduced party link information.

6. An information service system comprising:
the navigation apparatus according to claim 1; and
an introduced party link storage means for storing introduced party link information.

7. A navigation apparatus for a vehicle, the apparatus comprising:
a search condition input means for a user to input a search condition;
a control device that designates as a destination a facility which satisfies the inputted search condition;
an introducing party link acquisition means for acquiring introducing party link information relative to a facility which introduces a predetermined facility; and
an introducing facility selection means for the user to select an introducing facility included in the acquired introducing party link information,
wherein when a first facility, which satisfies the inputted search condition, is provided with linking party information relative to a facility which introduces the first facility,
(i) the control device reports, using a reporting means to the user, the introducing party link information relative to an introducing facility which introduces the first facility, and
(ii) the control device designates as a new destination an introducing facility selected by the user from the reported link information via the introducing facility selection means.

8. The navigation apparatus according to claim 7, further comprising:
a present position designation means for designating a present position,
when the introducing party link information, with which the first facility satisfying the inputted search condition is provided, includes a plurality of introducing facilities,
(i) the control device reports using a reporting means to the user the plurality of introducing facilities in an order of a distance from the present position, and
(ii) the control device designates as a new destination an introducing facility selected by the user from the plurality of introducing facilities included in the reported link information via the introducing facility selection means.

9. The navigation apparatus according to claim 7, wherein
when the introducing party link information, with which the first facility satisfying the inputted search condition is provided, includes a plurality of introducing facilities,
(i) the control device reports using a reporting means to the user the plurality of introducing facilities in an order of a distance from the first facility, and
(ii) the control device designates as a new destination a introducing facility selected by the user from the plurality of introducing facilities included in the reported link information via the introducing facility selection means.

10. The navigation apparatus according to claim 1, wherein:
the introducing party link acquisition means includes a storage medium reception means for receiving a detachable storage medium; and
the introducing party link acquisition means acquires the introducing party link information when the storage medium reception means receives a storage medium including the introducing party link information.

11. The navigation apparatus according to claim 1, wherein:
the introducing party link acquisition means includes a communication means; and
the introducing party link acquisition means acquires the introducing party link information when the communication means communicates with a center apparatus including the introducing party link information.

12. An information service system comprising:
the navigation apparatus according to claim 7; and
an introducing party link storage means for storing introducing party link information.

13. A navigation apparatus for a vehicle, the apparatus comprising:
a search condition input means for a user to input a search condition;
a control device that designates as a destination a facility which satisfies the inputted search condition;
an associated party link acquisition means for acquiring associated party link information relative to a facility, with which a predetermined facility is associated; and
an associated facility selection means for the user to select an associated facility included in the acquired associated party link information,
wherein when a first facility, which satisfies the inputted search condition, is provided with associated party link information relative to a facility the first facility is associated with,
(i) the control device reports using a reporting means, to the user, the associated party link information relative to the facility the first facility is associated with, and
(ii) the control device designates as a new destination an associated facility selected by the user from the reported link information via the associated facility selection means.

14. The navigation apparatus according to claim 13, wherein
the associated facility, which the first facility is associated with, includes at least one of (i) an introduced facility the first facility introduces and (ii) an introducing facility which introduces the first facility.
